(19) United States
(12) Patent Application Publication
(10) Pub. No.: US 2020/0401977 A1
(43) Pub. Date: Dec. 24, 2020

(54) SYSTEM AND METHOD FOR EVALUATION

(71) Applicant: DiDi Research America, LLC, Mountain View, CA (US)

(72) Inventors: Liwei REN, San Jose, CA (US); Xiaodan WANG, Los Altos, CA (US)

(21) Appl. No.: 16/444,985

(22) Filed: Jun. 18, 2019

(51) Int. Cl. G06Q 10/06; G06Q 10/10; H04L 12/58

(52) U.S. Cl. CPC G06Q 10/06393; G06Q 10/06398; H04L 51/12; G06Q 10/107; G06Q 10/103

(57) ABSTRACT

Methods, systems, and apparatus, including computer programs encoded on computer storage media, for evaluating teamwork are provided. One of the methods includes: obtaining a plurality of electronic communications among a plurality of team members from one or more computing devices supporting the electronic communications; determining a score for each of the plurality of electronic communications; and aggregating a plurality of the scores to obtain an evaluation of teamwork among the plurality of team members.

### TECHNICAL FIELD

The disclosure relates generally to automatically evaluating teamwork by computer.

### BACKGROUND

Organizations often need to evaluate the performances of individual members for determining bonus distributions, approving promotions, or making other decisions. However, there lacks a systematic way to evaluate teamwork or similar aspects of the team as a whole, for example, the effectiveness of collaboration among team members and leadership of the team manager, which are important metrics that the organizations would like to obtain for decision-makings. Traditionally, enterprise relationship management (ERM) softwares are tools that provide evaluation functions, which nevertheless still heavily rely on human inputs because their core mechanism is based on answering questionnaires by evaluators. The mere use of questionnaires to evaluate individuals makes the evaluations non-objective and non-automatic. Therefore, it is desirable to use computers to automatically score teamwork based on objective sources.

### SUMMARY

Various embodiments of the specification include, but are not limited to, systems, methods, and non-transitory computer readable media for evaluating teamwork.

In some embodiments, a computer-implemented method for evaluating teamwork comprises: obtaining a plurality of electronic communications among a plurality of team members from one or more computing devices supporting the electronic communications; determining a score for each of the plurality of electronic communications; and aggregating a plurality of the scores to obtain an evaluation of teamwork among the plurality of team members.

In some embodiments, obtaining the plurality of electronic communications comprises: receiving the plurality of electronic communications respectively from a plurality of filters installed on electronic communication servers; and the plurality of filters are configured to identify and filter out the plurality of electronic communications for the evaluation.

In some embodiments, the electronic communication servers comprise an email server and an instant messenger server.

In some embodiments, determining the score for each of the plurality of electronic communications comprises: determining the score for each of the plurality of electronic communications based on an electronic communication type, an electronic communication frequency, a time pattern of the electronic communication, a word scan for performance data, a word scan for appreciation, and a team project activity.

In some embodiments, aggregating the plurality of the scores to obtain the evaluation of teamwork among the plurality of team members comprises: summing the plurality of the scores over a measurement period to obtain the evaluation of teamwork among the plurality of team members.

In some embodiments, the evaluation of teamwork comprises an evaluation of collaboration; the plurality of electronic communications comprise electronic communications for collaboration purposes; and the plurality of electronic communications comprise at least one of the following subjects: team member schedule sharing, project meeting, and Q&A (questions and answers).

In some embodiments, the evaluation of teamwork comprises an evaluation of leadership; the plurality of electronic communications comprise electronic communications initiated by a manager for management purposes; and the plurality of electronic communications comprise at least one of the following subjects: individual meeting, team meeting, project meeting, promotion announcement, and team building activity.

In some embodiments, a system for evaluating teamwork comprises one or more processors and one or more non-transitory computer-readable memories coupled to the one or more processors and configured with instructions executable by the one or more processors to cause the system to perform operations comprising: obtaining a plurality of electronic communications among a plurality of team members from one or more computing devices supporting the electronic communications; determining a score for each of the plurality of electronic communications; and aggregating a plurality of the scores to obtain an evaluation of teamwork among the plurality of team members.

In some embodiments, a non-transitory computer-readable storage medium for evaluating teamwork is configured with instructions executable by one or more processors to cause the one or more processors to perform operations comprising: obtaining a plurality of electronic communications among a plurality of team members from one or more computing devices supporting the electronic communications; determining a score for each of the plurality of electronic communications; and aggregating a plurality of the scores to obtain an evaluation of teamwork among the plurality of team members.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the specification. It is to be understood that the foregoing general description and the following detailed description are exemplary and explanatory only, and are not restrictive of the specification, as claimed.

### BRIEF DESCRIPTION OF THE DRAWINGS

Non-limiting embodiments of the specification may be more readily understood by referring to the accompanying drawings in which:

FIG. 1 illustrates an exemplary system for evaluating teamwork, in accordance with various embodiments of the disclosure.

FIG. 2 illustrates an exemplary graph for evaluating teamwork, in accordance with various embodiments of the disclosure.

FIG. 3 illustrates an exemplary graph for evaluating teamwork, in accordance with various embodiments of the disclosure.

FIG. 4 illustrates a flow chart of an exemplary method for evaluating teamwork, in accordance with various embodiments of the disclosure.

FIG. 5 illustrates a block diagram of an exemplary computer system in which any of the embodiments described herein may be implemented.

### DETAILED DESCRIPTION

Non-limiting embodiments of the present specification will now be described with reference to the drawings. Particular features and aspects of any embodiment disclosed herein may be used and/or combined with particular features and aspects of any other embodiment disclosed herein. Such embodiments are by way of example and are merely illustrative of a small number of embodiments within the scope of the present specification. Various changes and modifications obvious to one skilled in the art to which the present specification pertains are deemed to be within the spirit, scope and contemplation of the present specification as further defined in the appended claims.

The approaches disclosed herein provide solutions for automatically and objectively evaluating teamwork and may include the following technical effects. The approaches may include collecting specific data from computing devices and making evaluations based on the collected data and a tailored model. In some embodiments, a computing system may obtain relevant electronic communications of team members (e.g., team manager, other team members) from computing devices (e.g., servers, mobile phones, computers) to rate the team members in terms of collaboration and/or leadership. For example, email communications, instant messages, and team project interactions may be filtered from data stored in the computing devices. The filtered electronic communications may be scored to provide bases for rating teamwork, such as the collaboration among team members and the leadership of the team manager. The entire process is enabled by specialized computer hardware and/or software, so that the evaluations take place automatically by machines while the team members carry out their regular electronic communications. Further, scoring the electronic communications may be based on objective factors such as electronic communication type, electronic communication frequency, time pattern of the electronic communication, word scan for performance data, word scan for appreciation, and team project activity. Thus, teamwork can be efficiently and accurately evaluated under an unified standard with minimal human cost, and the performance of the team as a whole can be measured and standardized.

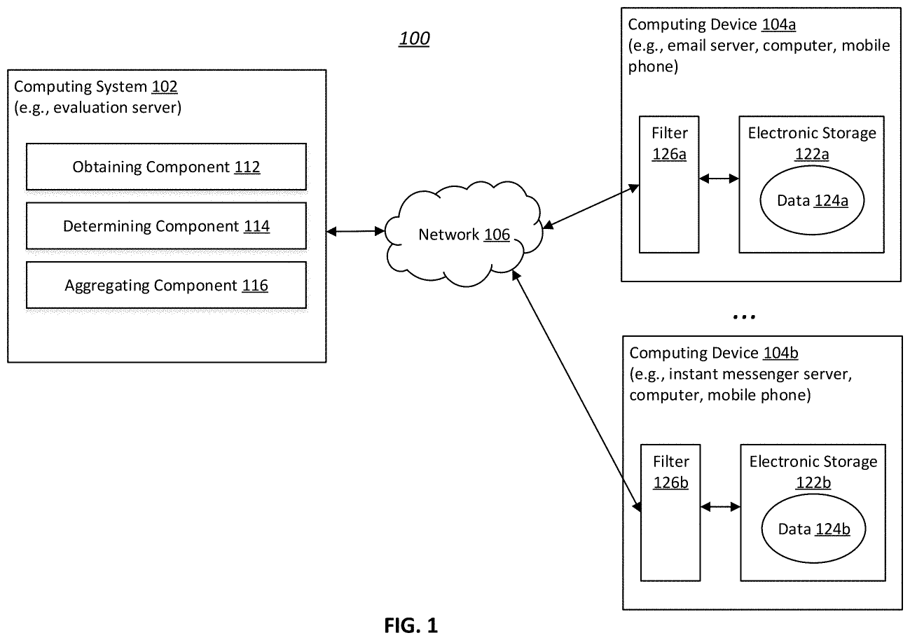

FIG. 1 illustrates an exemplary system 100 for evaluating teamwork, in accordance with various embodiments. The exemplary system 100 may include a computing system 102 (e.g., a server) and one or more computing devices (e.g., a client device, desktop, laptop, smartphone, tablet, mobile device) such as computing devices 104a and 104b. The computing system 102 and the computing devices 104a and 104b may each include one or more processors and one or more memories (e.g., permanent memory, temporary memory, non-transitory computer-readable storage medium). The processor(s) may be configured to perform various operations by interpreting machine-readable instructions stored in the memory. One or more of the computing system 102 and the computing devices 104a and 104b may include other computing resources or have access (e.g., via one or more connections/networks) to other computing resources. The computing system 102 may comprise one or more components described below, one or more of which may be optional. In one embodiment, each component may be a module configured to perform steps described below. In one embodiment, each component may comprise instructions stored in a non-transitory computer-readable storage medium. When the instructions are executed by a processor, the computing system 102 or the each component may be caused to perform steps described below. The various components may be implemented in hardware (e.g., artificial intelligence chip optimized for evaluating teamwork) and/or software (e.g., teamwork evaluation software).

The computing system 102 may include an obtaining component 112, a determining component 114, and an aggregating component 116. The computing system 102 may include other components. The computing system 102 and the computing devices 104a and 104b may be connected through one or more networks (e.g., a network 106). The computing system 102 and the computing devices 104a and 104b may exchange information using the network 106. The computing system 102 and the computing devices 104a and 104b may communicate over the network 106 using one or more electronic communication protocols. The computing system 102 may be a server of the network 106 and the computing devices 104a and 104b may be nodes of the network 106. The computing devices 104a and 104b may be computing devices from which teamwork-related electronic communications can be obtained. In some embodiments, the computing devices 104a and 104b may be directly used by the team members. For example, the computing devices 104a and 104b may be computers, mobile phones, tablets, or wearable devices used by the team members. In some embodiments, the computing devices 104a and 104b may be indirectly used by the team members. In one example, the computing device 104a may be an email server that has access to teamwork-related email communications, and the computing device 104b may be an instant messenger server that has access to teamwork-related instant message communications.

While the computing system 102 and the computing devices 104a and 104b are shown in FIG. 1 as single entities, this is merely for ease of reference and is not meant to be limiting. One or more components or functionalities of the computing system 102 or the computing devices 104a and 104b described herein may be implemented in a single computing device or multiple computing devices. For example, one or more components/functionalities of the computing system 102 may be implemented in the computing device 104a or 104b or distributed across multiple computing devices. For instance, the computing device 104a or 104b may represent a computing platform, such as an email system (e.g., Exchange, Gmail, firm email), an instant messenger system (e.g., DingTalk, Wechat, Facebook messenger, IMessenger), a collaboration system (e.g., Slack, wiki, Jira), a file server, etc. The components/functionalities of the computing system 102 may be implemented within the computing platform or in one or more other computing devices.

The computing device (104a, 104b) may include an electronic storage (122a, 122b). The electronic storage (122a, 122b) may refer to a device for storing information, such as electronic communications in any channel, group project work product (e.g., documents), etc. The electronic storage (122a, 122b) may include one or more storage media in which information may be stored. For example, the electronic storage (122a, 122b) may include optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), or other electronically readable storage media. The electronic storage may be part of the computing device (e.g., integrated into the computing device) or removably coupled to the computing device.

The electronic storage (122a, 122b) may store data (124a, 124b) and other information. The data (124a, 124b) may refer to information that is formatted for storage or used by one or more computing devices (104a, 104b). For example, the data (124a, 124b) may include one or more electronic files, executable programs, or other information stored or used by computing devices. A file may refer to a collection of data or information that has a name (e.g., filename). The data (124a, 124b) may include files of different types. For example, the data (124a, 124b) may include one or more of the following file types: data files (e.g., WORD, PDF), text files, program files, attachment files (e.g., pictures, diagrams, documents), temporary files. Other types of files are contemplated. Files within the data (124a, 124b) may be stored within a single storage media or across multiple storage media. Files within the data (124a, 124b) may be stored within a single file directory or across multiple file directories. Other types of information within the data are contemplated.

The computing device (104a, 104b) may include a filter (126a, 126b) coupled to the electronic storage (122a, 122b). The filter (126a, 126b) may refer to a specialized hardware (e.g., artificial intelligence chip optimized for filtering) and/or software (e.g., filtering software) configured to filter out the data (124a, 124b) for retrieval by the computing system 102. The filter may be configured to filter out teamwork-related information. In some embodiments, the filter may be integrated in the corresponding computing device as shown, integrated in the computing system 102, or disposed outside and coupled to the computing device and the computing system. The filter may be tailored to identify electronic communications for teamwork evaluation and send such identified electronic communications to the computing system 102. For example, an filter integrated in an email server may be configured to filter out teamwork information by scanning email contents and extract electronic communications comprising keywords related to the team (e.g., emails addressed to team members, emails comprising comments about team projects, etc.).

The obtaining component 112 may be configured to obtain a plurality of electronic communications among a plurality of team members from one or more computing devices supporting the electronic communications. The electronic communications may comprise any type of information communicated by one or more team members of a team. The electronic communications may be exchanged or shared with one or more other persons who may or may not be on the team. The electronic communications may not necessarily be received by any person. The electronic communications may comprise the data (e.g., 124a, 124b) described above. The electronic communications may comprise, for example, emails, text messages, voice mails, project documents, progress or other documentations, internet posts, etc.

In some embodiments, the computing devices supporting the electronic communications may comprise a computing device directly or indirectly used by a team member, such as the computing devices 104a, 104b described above. The computing devices supporting the electronic communications may comprise user-end devices directly effectuating the electronic communications or intermediate equipment for facilitating the electronic communications.

In some embodiments, obtaining the plurality of electronic communications comprises: receiving the plurality of electronic communications respectively from a plurality of filters (e.g., 126a, 126b) installed on electronic communication servers; and the plurality of filters are configured to identify and filter out the plurality of electronic communications for the evaluation. In some embodiments, the electronic communication servers comprise an email server and an instant messenger server.

The determining component 114 may be configured to determine a score for each of the plurality of electronic communications. Various scoring techniques can be used, including scoring based on machine learning. In some embodiments, determining the score for each of the plurality of electronic communications comprises: determining the score for each of the plurality of electronic communications based on an electronic communication type, an electronic communication frequency, a time pattern of the electronic communication, a word scan for performance data, a word scan for appreciation, and a team project activity. For example, formal electronic communications through firm email accounts, more frequent electronic communications, or electronic communications occurred outside work hours may be given a larger weight in terms of scoring. A word scan of the electronic communication performed by the filter and/or the computing system may detect information that helps determine the score. For example, detecting performance data in an electronic communication may indicate express discussions of the team project progress and provide a basis for giving a higher score. Detecting appreciation in an electronic communication may indicate a positive team environment and provide a basis for giving a higher score. Detecting team project activity may directly reflect the team project progress and provide a basis for scoring based on the progress and target.

The aggregating component 116 may be configured to aggregate a plurality of the scores to obtain an evaluation of teamwork among the plurality of team members. The team members may include one or more managers and one or more other team members. In some embodiments, aggregating the plurality of the scores to obtain the evaluation of teamwork among the plurality of team members comprises: summing the plurality of the scores over a measurement period (e.g., one year, half a year, or another configurable time period) to obtain the evaluation of teamwork among the plurality of team members. Other aggregation methods other than summing to obtain the evaluation are contemplated.

In some embodiments, the evaluation of teamwork comprises an evaluation of collaboration; the plurality of electronic communications comprise electronic communications for collaboration purpose; and the plurality of electronic communications comprise at least one of the following subjects: team member schedule sharing, project, and Q&A. Collaboration among the plurality of team members may refer to cooperative teamwork among the team members. The subjects may be determined by word-scanning the electronic communications by the filters. Collaboration may refer to two or more people working on a common project or otherwise towards a common goal to produce or create something. Based on team member schedule sharing electronic communications, it may be determined that, for example, how many of the team members share their schedules, as a metric for scoring collaboration. Based on project meeting electronic communications, it may be determined that, for example, how often project meetings are held, how long project meetings are held, or how much the progress advances with respect to project meetings, as a metric for scoring collaboration. Based on Q&A electronic communications, it may be determined that, for example, how many questions are raised and how many are answered with respect to collaborative projects, as a metric for scoring collaboration.

In some embodiments, the evaluation of teamwork comprises an evaluation of leadership; the plurality of electronic communications comprise electronic communications initiated by a manager for management purposes; and the plurality of electronic communications comprise at least one of the following subjects: individual meeting, team meeting, project meeting, promotion announcement, and team building activity. Leadership among the plurality of team members may refer to the leadership of the team manager with respect to leading one or more other team members. The subjects may be determined by word-scanning the electronic communications by the filters. Management may refer to dealing with or controlling team members. Based on individual meeting electronic communications, it may be determined that, for example, how responsive the manager is towards granting one-on-one meetings, or how often the manager initiates one-on-one meetings, as a metric for scoring leadership. Based on team or project meeting electronic communications, it may be determined that, for example, how often the manager initiates such meetings, as a metric for scoring leadership. Based on promotion announcement electronic communications, it may be determined that, for example, how often the manager announces promotions, as a metric for scoring leadership. Based on team building activity electronic communications, it may be determined that, for example, how many team building activities have been organized by the manager, as a metric for scoring leadership.

In some embodiments, artificial intelligence (machine learning) techniques may be used to evaluate collaboration, leadership, or another aspect of teamwork. For example, the determining component 114 may be configured to determine the score using a neural network-based evaluation model. In an exemplary neural network-based evaluation model, each metric or basis for evaluation described herein may be treated as a state of the electronic communication to input to the model. Accordingly, each input may comprise various states such as electronic communication type, electronic communication time, electronic communication participants, word scan results, etc. The states may be fed through the network (that has been trained) to output a score of the electronic communication. Aggregated scores can be used to make the teamwork evaluation. The network may comprise a plurality of nodes organized in various ways, such as arranged in layers (or columns) according to different designs. The nodes may be organized in a deep neural network (DNN), convoluted neural network (CNN), recurrent neural network (RNN), etc. Different nodes or layers of nodes are connected by different weights which have been adjusted during training of the network to optimize for accurately generating outputs. The training may be performed by feeding the network (that has not been trained) with training data (e.g., electronic communications that have been manually or otherwise scored) to tune the weights. Thus, determining the score for each of the plurality of electronic communications may comprise feeding the each of the plurality of electronic communications to the trained network to determine the score. Notwithstanding, various other ways of organizing the nodes or scoring the electronic communications are contemplated.

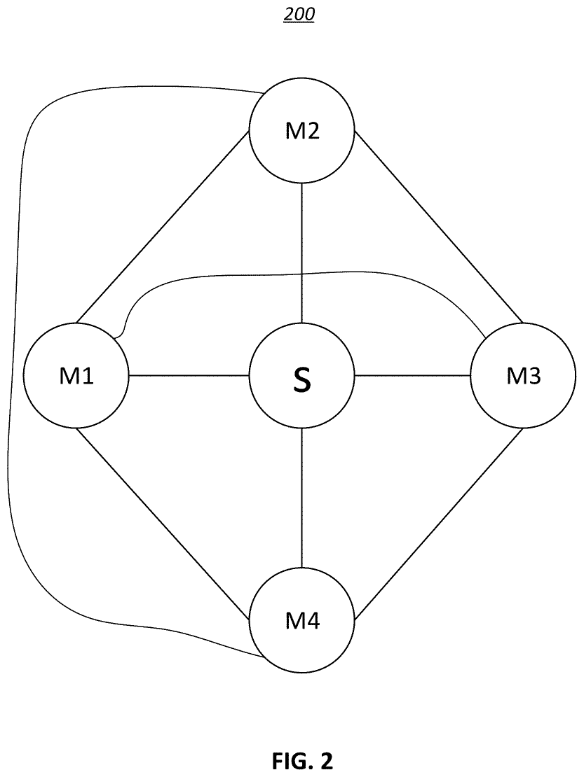

FIG. 2 illustrates an exemplary graph 200 for evaluating collaboration, in accordance with various embodiments of the disclosure. The graph 200 may be a complete graph (collaboration graph) and may comprise a master vertex S (representing a team manager) and regular vertices M1, M2, M3, M4 (representing team members other than the manager). Notwithstanding, other number of managers and team members are contemplated. The graph 200 may be applied in performing any disclosed method.

In some embodiments, with respect to a collaboration model, for any period of time, the electronic communications between all vertices can be used to evaluate the leadership and collaboration. The electronic communications can be divided into two categories: (1) peer electronic communications (e.g., electronic communications among all team members except the manager, electronic communications from all team members for non-management purpose) for evaluating collaboration and (2) leadership electronic communications (e.g., electronic communication initiated by the team manager for management purpose) for evaluating leadership of the manager. The peer electronic communication may include electronic communications with the manager's manager and other team members.

In some embodiments, each electronic communication may be scored. Scoring may be based on the number of communicators and the style of electronic communication, such as one-to-all, one-to-many, one-to-one, etc. Scoring may be based on the nature of the electronic communication, such as email, message, internet post, etc. Scoring may also be based on the frequency of electronic communication, the pattern of electronic communication (e.g., time of the day/week/month/year), performance data comprised in the electronic communication, words of gratitude or appreciation comprised in the electronic communication, activities on teamwork platforms or related productivity tools, etc.

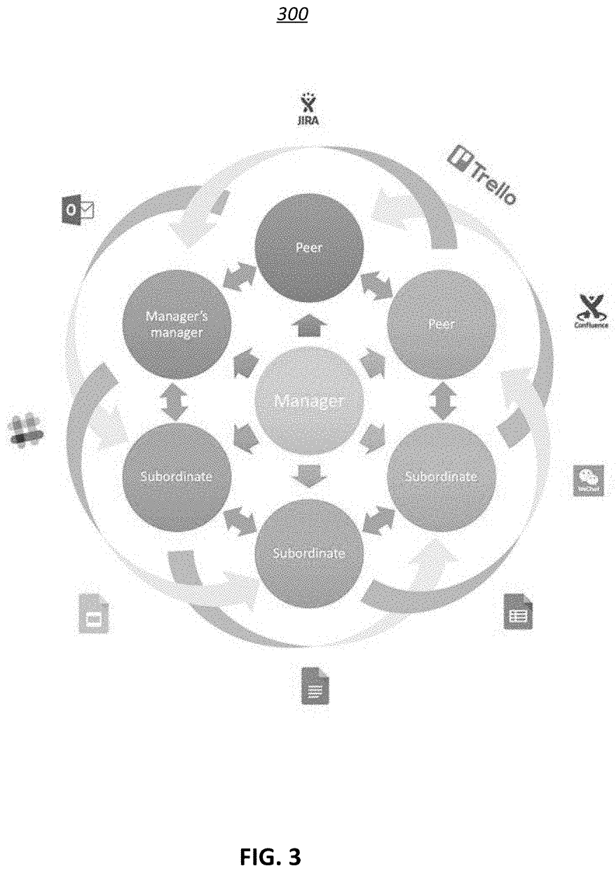

FIG. 3 illustrates an exemplary graph 300 for evaluating teamwork, in accordance with various embodiments of the disclosure. The graph 300 may be applied in performing any disclosed method. In some embodiments, the graph 200 (a single team model) may be extended into a hierarchical structure for a whole organization such as a company or a non-profit organization shown as the graph 300. As shown, the vertices may involve a manager, the manager's manager, peer managers, subordinates (e.g., other team members), etc. Various icons representing different types of electronic communications are shown around the relationship arrows. Similar to the descriptions above, the electronic communications among these vertices may be scored to evaluate leadership and collaboration among the vertices.

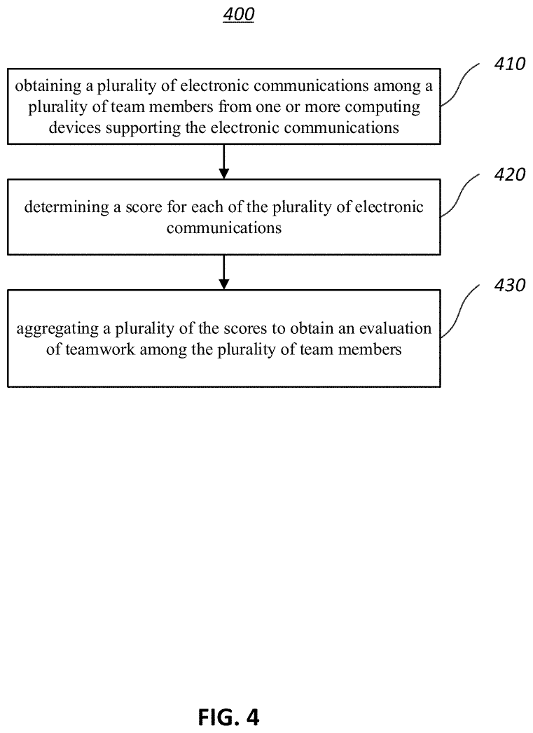

FIG. 4 illustrates a flowchart of an exemplary method 400 for evaluating teamwork, according to various embodiments of the present disclosure. The method 400 may be implemented in various environments including, for example, the system 100 of FIG. 1, etc. The operations of the method 400 presented below are intended to be illustrative. Depending on the implementation, the method 400 may include additional, fewer, or alternative steps performed in various orders or in parallel. The method 400 may be implemented in various computing systems or devices including one or more processors.

With respect to the method 400, block 410 includes obtaining a plurality of electronic communications among a plurality of team members from one or more computing devices supporting the electronic communications. Block 420 includes determining a score for each of the plurality of electronic communications. Block 430 includes aggregating a plurality of the scores to obtain an evaluation of teamwork among the plurality of team members. Details of the steps can be referred to the descriptions above with reference to FIG. 1 to FIG. 3.

One or more blocks of the method 400 may be performed by one or more computer components that are the same as or similar to the components of the computing system 102 shown in FIG. 1. For example, the block 410 may be performed by a computer component the same as or similar to the obtaining component 112. The block 420 may be performed by a computer component the same as or similar to the determining component 114. The block 430 may be performed by a computer component the same as or similar to the aggregating component 116.

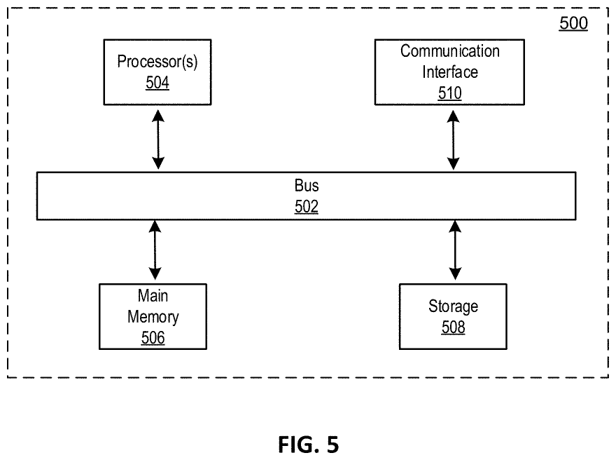

FIG. 5 is a block diagram that illustrates a computer system 500 upon which any of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor(s) 504. Main memory 506 also may be used for storing temporary variables or other intermediate information during execution of instructions to be executed by processor(s) 504. Such instructions, when stored in storage media accessible to processor(s) 504, render computer system 500 into a special-purpose machine that is customized to perform the operations specified in the instructions. Main memory 506 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, an EPROM, a FLASH-EPROM, NVRAM, any other memory chip or cartridge, and networked versions of the same.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 508. Execution of the sequences of instructions contained in main memory 506 causes processor(s) 504 to perform the process steps described herein.

For example, the computing system 500 may be used to implement the computing system 102 or one or more components of the computing system 102 shown in FIG. 1. As another example, the process/method shown in FIG. 4 and described in connection with this figure may be implemented by computer program instructions stored in main memory 506. When these instructions are executed by processor(s) 504, they may perform the steps as shown in FIG. 4 and described above. In alternative embodiments, hard-wired circuitry may be used in place of or in combination with software instructions.

The computer system 500 also includes a communication interface 510 coupled to bus 502. Communication interface 510 provides a two-way data communication coupling to one or more network links that are connected to one or more networks. As another example, communication interface 510 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A computer-implemented method for evaluating teamwork, comprising:
obtaining a plurality of electronic communications among a plurality of team members from one or more computing devices supporting the electronic communications;
determining a score for each of the plurality of electronic communications; and
aggregating a plurality of the scores to obtain an evaluation of teamwork among the plurality of team members.

2. The method of claim 1, wherein:
obtaining the plurality of electronic communications comprises: receiving the plurality of electronic communications respectively from a plurality of filters installed on electronic communication servers; and
the plurality of filters are configured to identify and filter out the plurality of electronic communications for the evaluation.

3. The method of claim 2, wherein:
the electronic communication servers comprise an email server and an instant messenger server.

4. The method of claim 1, wherein determining the score for each of the plurality of electronic communications comprises:
determining the score for each of the plurality of electronic communications based on an electronic communication type, an electronic communication frequency, a time pattern of the electronic communication, a word scan for performance data, a word scan for appreciation, and a team project activity.

5. The method of claim 1, wherein aggregating the plurality of the scores to obtain the evaluation of teamwork among the plurality of team members comprises:
summing the plurality of the scores over a measurement period to obtain the evaluation of teamwork among the plurality of team members.

6. The method of claim 1, wherein:
the evaluation of teamwork comprises an evaluation of collaboration;
the plurality of electronic communications comprise electronic communications for collaboration purposes; and
the plurality of electronic communications comprise at least one of the following subjects: team member schedule sharing, project meeting, and Q&A (questions and answers).

7. The method of claim 1, wherein:
the evaluation of teamwork comprises an evaluation of leadership;
the plurality of electronic communications comprise electronic communications initiated by a manager for management purposes; and
the plurality of electronic communications comprise at least one of the following subjects: individual meeting, team meeting, project meeting, promotion announcement, and team building activity.

8. A system for evaluating teamwork, comprising one or more processors and one or more non-transitory computer-readable memories coupled to the one or more processors and configured with instructions executable by the one or more processors to cause the system to perform operations comprising:
obtaining a plurality of electronic communications among a plurality of team members from one or more computing devices supporting the electronic communications;
determining a score for each of the plurality of electronic communications; and
aggregating a plurality of the scores to obtain an evaluation of teamwork among the plurality of team members.

9. The system of claim 8, wherein:
obtaining the plurality of electronic communications comprises: receiving the plurality of electronic communications respectively from a plurality of filters installed on electronic communication servers; and
the plurality of filters are configured to identify and filter out the plurality of electronic communications for the evaluation.

10. The system of claim 9, wherein:
the electronic communication servers comprise an email server and an instant messenger server.

11. The system of claim 8, wherein determining the score for each of the plurality of electronic communications comprises:
determining the score for each of the plurality of electronic communications based on an electronic communication type, an electronic communication frequency, a time pattern of the electronic communication, a word scan for performance data, a word scan for appreciation, and a team project activity.

12. The system of claim 8, wherein aggregating the plurality of the scores to obtain the evaluation of teamwork among the plurality of team members comprises:
summing the plurality of the scores over a measurement period to obtain the evaluation of teamwork among the plurality of team members.

13. The system of claim 8, wherein:
the evaluation of teamwork comprises an evaluation of collaboration;
the plurality of electronic communications comprise electronic communications for collaboration purposes; and
the plurality of electronic communications comprise at least one of the following subjects: team member schedule sharing, project meeting, and Q&A (questions and answers).

14. The system of claim 8, wherein:
the evaluation of teamwork comprises an evaluation of leadership;
the plurality of electronic communications comprise electronic communications initiated by a manager for management purposes; and
the plurality of electronic communications comprise at least one of the following subjects: individual meeting, team meeting, project meeting, promotion announcement, and team building activity.

15. A non-transitory computer-readable storage medium for evaluating teamwork, configured with instructions executable by one or more processors to cause the one or more processors to perform operations comprising:
obtaining a plurality of electronic communications among a plurality of team members from one or more computing devices supporting the electronic communications;
determining a score for each of the plurality of electronic communications; and
aggregating a plurality of the scores to obtain an evaluation of teamwork among the plurality of team members.

16. The storage medium of claim 15, wherein:
obtaining the plurality of electronic communications comprises: receiving the plurality of electronic communications respectively from a plurality of filters installed on electronic communication servers; and
the plurality of filters are configured to identify and filter out the plurality of electronic communications for the evaluation.

17. The storage medium of claim 16, wherein:
the electronic communication servers comprise an email server and an instant messenger server.

18. The storage medium of claim 15, wherein determining the score for each of the plurality of electronic communications comprises:
determining the score for each of the plurality of electronic communications based on an electronic communication type, an electronic communication frequency, a time pattern of the electronic communication, a word scan for performance data, a word scan for appreciation, and a team project activity.

19. The storage medium of claim 15, wherein:
the evaluation of teamwork comprises an evaluation of collaboration;
the plurality of electronic communications comprise electronic communications for collaboration purposes; and
the plurality of electronic communications comprise at least one of the following subjects: team member schedule sharing, project meeting, and Q&A (questions and answers).

20. The storage medium of claim 15, wherein:
the evaluation of teamwork comprises an evaluation of leadership;
the plurality of electronic communications comprise electronic communications initiated by a manager for management purposes; and
the plurality of electronic communications comprise at least one of the following subjects: individual meeting, team meeting, project meeting, promotion announcement, and team building activity.
